(19) United States
(12) Patent Application Publication
(10) Pub. No.: US 2021/0156468 A1
(43) Pub. Date: May 27, 2021

(54) METHOD AND MOVEMENT DEVICE FOR MOVING AT LEAST PART OF A MANUALLY OPERABLE OPERATING DEVICE FOR OPERATING A FUNCTION OF A VEHICLE, AND MOVEMENT SYSTEM COMPRISING A MOVEMENT DEVICE AND AN OPERATING MECHANISM

(71) Applicant: ZF Friedrichshafen AG, Friedrichshafen (DE)

(72) Inventor: Lenard Petrzik, Osnabrück (DE)

(73) Assignee: ZF Friedrichshafen AG, Friedrichshafen (DE)

(21) Appl. No.: 16/647,199

(22) PCT Filed: Aug. 13, 2018
(86) PCT No.: PCT/EP2018/071848

§ 371 Date: Mar. 13, 2020

(30) Foreign Application Priority Data
Sep. 13, 2017 (DE) 10 2017 216 178.7

(51) Int. Cl. F16H 59/02; B60W 60/00; B60W 50/08; B60K 37/06; B60N 2/75; F16H 59/08

(52) U.S. Cl. CPC F16H 59/0278; B60W 60/0051; B60W 50/082; B60K 37/06; B60N 2/797; F16H 2059/026; B60K 2370/126; B60K 2370/1438; B60K 2370/197; B60K 2370/682; F16H 2059/081; F16H 59/08

(57) ABSTRACT

A method for moving at least part of a manually operable operating device for operating a function of a vehicle is described. The operating device comprises an operating element and a cover element for covering the operating element. The method comprises at least an input step and an output step. A driving operating state signal is input in the input step that represents a selected driving operating state of the vehicle in a driving mode of the vehicle. A movement signal is output in the output step that is configured to cause a movement of the operating element or the cover element, depending on the input driving operating state signal.

### RELATED CASES

This application is a filing under 35 U.S.C. § 371 of International Patent Application PCT/EP2018/071848, filed Aug. 13, 2018, and claiming priority to German Patent Application 10 2017 216 178.7, filed Sep. 13, 2017. All applications listed in this paragraph are hereby incorporated by reference in their entireties.

### BACKGROUND

The present invention relates to a method and movement device for moving at part of a manually operable operating device for operating a function of a vehicle and a movement system comprising a movement device and an operating mechanism.

Control knobs in vehicles are known that project from a central console when the vehicle is started, thus providing the driver of the vehicle with a gear selection.

Based on this, the present invention results in an improved method and an improved movement device for moving at least part of a manually operable operating device for operating a function of a vehicle and a movement system with an improved movement device and an operating device according to the independent claims. Advantageous embodiments can be derived from the dependent claims and the following description.

The advantages that can be obtained with the invention presented herein are that a method presented herein allows for an operating element of a vehicle only to be operated by a driver of the vehicle when the driver actually needs the operating element. This results in a cognitive relief for the driver while driving.

### BRIEF DESCRIPTION OF THE DRAWINGS

Exemplary embodiments of the invention presented herein are shown in the drawings and explained in greater detail in the following description. Therein:

FIGS. 1 to 4 show a schematic illustration of a movement system comprising a movement device and an operating device according to exemplary embodiments; and

FIG. 5 shows a flow chart for a method for moving a manually operable operating device for operating a function of a vehicle according to an exemplary embodiment.

### DETAILED DESCRIPTION

A method for moving at least part of a manually operable operating device for operating a function of a vehicle is presented herein. The operating device comprises an operating element and a cover element for coving the operating element. The method comprises at least one input step and one output step. A driving operating state signal is input in the input step that represents an operating state of the vehicle when the vehicle is in operation. A movement signal is output in the output step that is configured to move the operating element or the cover element, depending on the operating state signal.

The operating state can be a manually controlled driving operating state in which the driver actively controls the driving manually. This can also be a highly automated operating state in which the driver does not participate in the driving and the vehicle is controlled in a highly automated manner.

The operating element can be an element by means of which the driver can manually operate or select a function of the vehicle. By way of example, the operating element can be a control knob that sets a gear selection for the vehicle transmission in response to operation thereof by the driver.

By moving the operating device in response to the operating state signal, the operating element can be released for use by the driver, depending on the operating state, thus making it accessible, or blocked, i.e. inaccessible.

It is advantageous when an operating movement signal is output as the movement signal in the output step, which is configured to cause a movement of the operating element or the cover element in an operating position of the operating device in which the operating element is accessible to the driver of the vehicle when the operating state signal is input in the input step, in which the operating state of the vehicle that has be selected represents a manually controlled driving operation. The movement of the operating element or the cover element into the operating position clearly indicates to the driver that he must now control the driving.

By way of example, the operating movement signal can be output in the output step, which is configured to cause a movement of the operating element out from under the cover element, and/or to move the cover element away from the operating element, in order to switch the operating device into the operating position. In this manner, a concealed operating element can be revealed.

It is also advantageous when a standby movement signal is output as the movement signal in the output step, which is configured to cause a movement of the operating element or the cover element into a standby position of the operating device, in which the operating element is inaccessible to the driver of the vehicle, when the operating state signal is input in the input step in which the operating state of the vehicle that has been selected represents a highly automated driving operation. The movement of the operating element or the cover element into the standby position clearly indicates to the driver that the driving will now be controlled in a highly automated manner and the driver no longer needs to participate in the driving.

The standby movement signal can be output in the output step, for example, which is configured to cause the operating element to move under the cover element and/or the cover element to move over the operating element, in order to switch the operating element into the standby position. In this manner, a visible operating element can be concealed or covered.

A movement device is configured to execute and/or actuate the steps in the method in one of the variations that are presented herein in corresponding units.

This movement device can be an electric device that processes electric signals, e.g. sensor signals, and outputs control signals based thereon. The movement device can comprise one or more appropriate hardware and/or software interfaces. Hardware interfaces can be part of an integrated circuit, for example, in which functions of the movement device are implemented. The interfaces can also be individual integrated circuits, or at least partially made of discrete components. Software interfaces can be interfaces in software modules, in addition to other software modules on a microcontroller, for example.

A movement system comprises the movement device presented herein and the operating device presented herein, and is configured for use in a vehicle.

The operating element in the movement system can be a gear knob, in particular the control knob for selecting the gear setting, and/or a toggle switch, and/or button, and/or touchscreen, and/or light switch, and/or steering wheel. Such operating elements are operated by the driver during a manually controlled operating state of the vehicle, and are not needed by the driver during a highly automated operating state.

The cover element of the movement system can be designed as an armrest and/or arm support, e.g. a central console armrest, and/or a display, e.g. an information element, in particular a further touchscreen, and/or a central control element, and/or an air conditioning control element.

A computer program containing program code is also advantageous, which can be stored on a machine-readable medium, e.g. a semiconductor memory, a hard disk memory, or optical memory, and is used for executing the method according to any of the embodiments described above when the program is executed on a computer or a device.

In the following description of preferred exemplary embodiments of the present invention, the same or similar reference symbols are used for elements with similar functions depicted in the figures, wherein a description of these elements shall not be repeated.

If an exemplary embodiment comprises an “and/or” conjunction between a first feature and a second feature, this is to be read to mean that the exemplary embodiment contains both the first feature and the second feature according to one embodiment, and contains either just the first feature or just the second feature according to another embodiment.

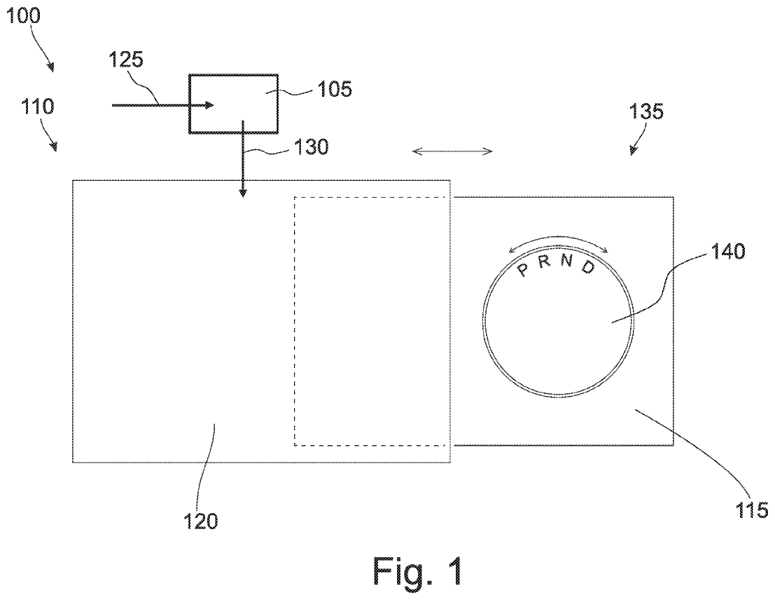

FIG. 1 shows a schematic illustration of a movement system 100 comprising a movement device 105 and an operating device 110 according to an exemplary embodiment.

The movement device 105 is configured to move the operating device 110. The operating device 110 can be operated manually and is configured for operating a function of a vehicle. The operating device 110 contains an operating element 115 for this, and a cover element 120 for covering the operating element 115.

The movement device 105 is configured to input a driving operating state signal 125 that represents an operating state of the vehicle that has been selected when operating the vehicle. Moreover, the movement device 105 is configured to output a movement signal 130 based on the input operating state signal 125, which is configured to cause a movement of the operating element 115 or the cover element 120.

The features of the movement device 105 and the operating device 110 described below are optional.

According to this exemplary embodiment, the operating element 110 is in an operating position 135, in which the operating element 115 is accessible to the driver of the vehicle. The operating element 115 comprises a control knob 140 for selecting a gear setting.

According to this exemplary embodiment, the movement device 105 outputs a standby movement signal as the movement signal 130, which is configured to cause a movement of the cover element 120 from the operating position 135 shown herein to a standby position of the operating device 110, in which the operating device 115 is inaccessible to the driver of the vehicle, because an operating state signal 125 has been input as the operating state signal 125, in which the selected operating state of the vehicle represents a highly automated driving mode.

According to this exemplary embodiment, the movement device 105 outputs a standby movement signal that is configured to cause the cover element 120 to move over the operating element 115, in order to switch the operating device 110 into the standby position.

Details of the movement system 100 that have already been described shall be explained below again, in a different manner.

Driving functions of the vehicle are made available by the movement device 105 presented herein, depending on the driving situation.

There are two situations for the use of the product: in a first situation, the operating element 115 is accessible, i.e. exposed, and in a second situation, the operating element 115 is not accessible, i.e. covered.

In differing from the known systems in which a control knob projects from a central console when the vehicle is started, and provides the driver with a gear selection, the operating element 115 is only perceptible to the driver when the vehicle is in a manually controlled driving mode, due to the movement device 105 presented herein. As a result, the driver is cognitively relieved, because he is not presented with any information in situations in which he does not need this information. The movement device 110 shown herein also exhibits no clearance, in contrast to known systems, such that dirt and moisture cannot enter it. This construction is also easier to implement.

As a result of the increasing automation of passenger cars, certain functions are not permanently needed, depending on the situation. If functions are displayed that are not relevant or cannot be operated in a current situation, the cognitive load to the driver is substantially increased. The driver needs clear signals indicating when which functions are relevant or can be operated, for assuming/switching between autonomous or highly automated vehicle control and manual vehicle control.

The movement device 115 allows for the operating element 115 to be covered by a mechanical cover in the form of the cover element 120, depending on the situation. As a result, the availability of functions is adapted to the current driving situation, controlled manually or highly automated, and thus reduces the cognitive load to the driver.

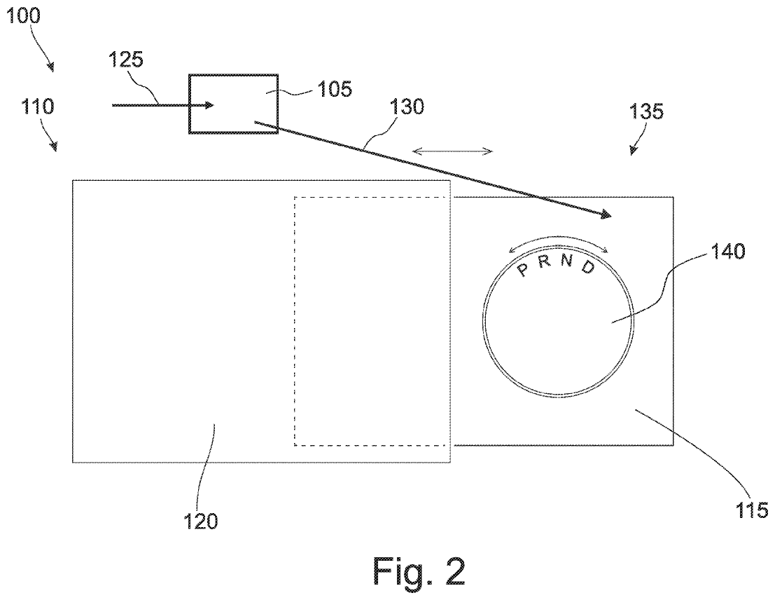

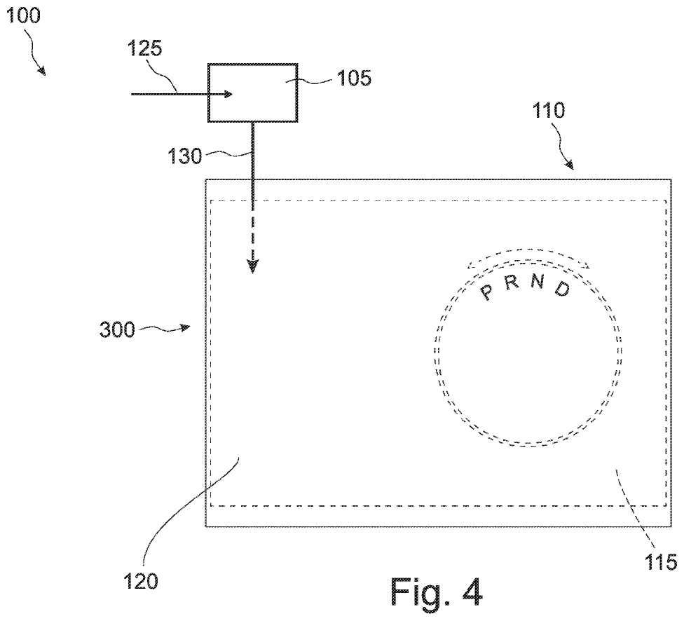

Either the cover element 120 can be moved over the operating element 115 by the movement device 105, and the operating element 115 is then exposed in that the cover element 120 returns to its original position. Alternatively, the operating element 115 can be moved under the cover element 120, and the operating element 115 is moved back out from under the cover element 120, see FIGS. 2 and 4.

FIG. 2 shows a schematic illustration of a movement system 100 that comprises a movement device 105 and an operating device 110 according to an exemplary embodiment. This can be the movement system 100 described in reference to FIG. 1, in which the operating device 110 is in the operating position 135 and the driving operating state signal 125 is input, in which the selected operating state of the vehicle represents the highly automated driving mode.

According to this exemplary embodiment, the movement device 105 outputs a standby movement signals as the movement signal 130, which is configured to cause a movement, not of the cover element 120, but of the operating element 115 from the operating position 135 to the standby position of the operating device 110. For this, the movement device 105 outputs a standby movement signal that is configured to cause the operating element 115 to move under the cover element 120, in order to switch the operating device 110 into the standby position.

The following is another explanation of FIG. 2 based on an example: The driver is driving the vehicle manually. The operating element 115 for controlling the transmission, formed by the control knob 140, is visible and can be operated. As soon as the driver stops operating the vehicle manually, and the highly automated vehicle control is activated, the movement device 105 outputs the standby movement signal and the control knob 140 is moved under the cover element 120, which is an armrest according to this exemplary embodiment. The driver then knows that he cannot, or does not need to, operate this operating element 115, and is thus relieved of this. He is made aware that he no longer needs to actively control the vehicle.

Alternatively or in addition to the control knob 140, the operating element 115 according to an alternative exemplary embodiment comprises a gear knob and/or a toggle switch, and/or a push button, and/or a touchscreen, e.g. a SwipeTronic, and/or a light switch, and/or a steering wheel.

The armrest in the form of the cover element 120 forms a central console armrest according to this exemplary embodiment, and in an alternative exemplary embodiment, the armrest is an arm support on the vehicle seat or an arm support on the vehicle door. Alternatively or additionally to the armrest 140, the cover element 120 according to an alternative exemplary embodiment comprises a display for an information element in the vehicle and/or another touchscreen in a central control element and/or an air conditioning element for the vehicle.

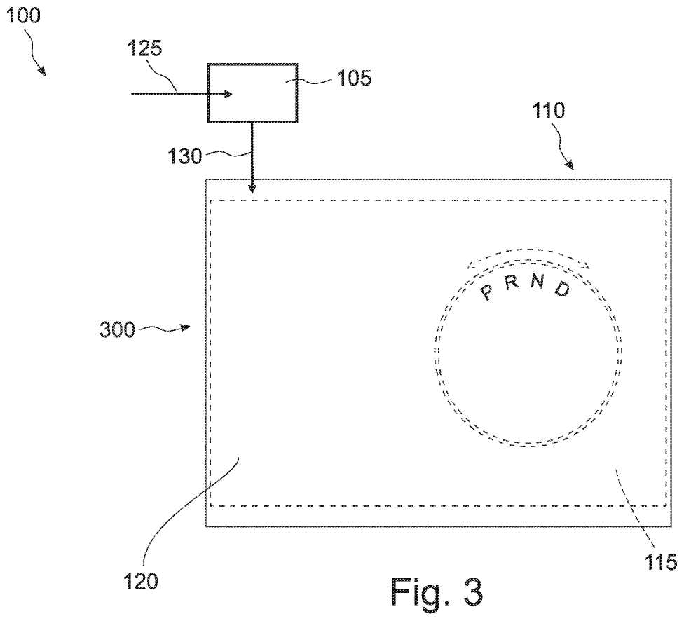

FIG. 3 shows a schematic illustration of a movement system 100 comprising a movement device 105 and an operating device 110 according to an exemplary embodiment. This can be the movement system 100 described in reference to FIGS. 1 and 2, with the difference that the operating device 110 is in the standby position 300.

According to this exemplary embodiment, the movement device 105 outputs an operating movement signal as the movement signal 130, which is configured to cause a movement of the cover element 120 from the standby position 300 shown herein to the operating position of the operating device 110, which is input according to this exemplary embodiment as the operating state signal 125 of a driving operating state signal 125, in which the selected driving operating state of the vehicle represents a manually controlled driving mode.

According to this exemplary embodiment, the movement device 105 outputs an operating movement signal that is configured to cause a movement of the cover element 120 away from the operating element 115, in order to switch the operating device 110 into the operating position.

FIG. 4 shows a schematic illustration of a movement system 100 comprising a movement device 105 and an operating device 110 according to an exemplary embodiment. This can be the movement system 100 described in reference to FIG. 3, in which the operating device 110 is in the standby position 300, and the driving operating state signal 125 is input, in which the input driving operating state of the vehicle represents the manually controlled driving mode.

According to this exemplary embodiment, the movement device outputs an operating movement signal as the movement signal 130, which is configured to cause a movement, not of the cover element 120, but of the operating element 115 from the standby position 300 into the operating position for the operating device 110. The movement device 105 outputs an operating movement signal for this, which is configured to cause a movement of the operating element 115 out from under the cover element 120, in order to switch the operating device 110 into the operating position.

In other words, the driver in FIG. 4 abandons the autonomous driving mode and assumes manual control of the vehicle. The control knob is made available again by the operating movement signal in that it moves out from under the armrest, and thus indicates that the vehicle can, or must, be controlled actively.

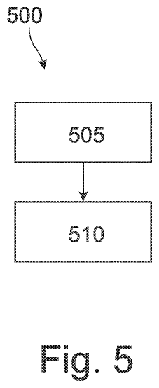

FIG. 5 shows a flow chart for a method 500 for moving at least part of a manually operably operating element for operating a function of a vehicle according to an exemplary embodiment. This can be the operating device described in reference to any of the FIGS. 1 to 4. The method 500 can be actuated and/or executed by any of the movement devices described in reference to FIGS. 1 to 4.

The method 500 comprises at least one input step 505 and one output step 510. A driving operating state signal is input in the input step 505, which represents a selected operating state of the vehicle in an operating mode of the vehicle. A movement signal is output in the output step 510, which is configured to cause a movement of the operating element or the cover element, depending on the input driving operating state signal.

According to this exemplary embodiment, an operating movement signal is output in the output step 510 as the movement signal that is configured to cause a movement of the operating element or the cover element into an operating position for the operating device in which the operating element is accessible to the driver of the vehicle, because the driving operating state signal in which the selected driving operating state of the vehicle represents a manually controlled driving mode is input in the input step 505.

According to this exemplary embodiment, the operating movement signal is output in the output step 510, which is configured to cause a movement of the operating element out from under the cover element and/or a movement of the cover element away from the operating element, in order to switch the operating device into the operating position.

According to an alternative exemplary embodiment, a standby movement signal is output in the output step 510 that is configured to cause a movement of the operating element or the cover element into a standby position of the operating device, in which the operating element is inaccessible to a driver of the vehicle, because the driving operating state signal has been input in the input step 505, in which the selected driving operating state of the vehicle represents a highly automated driving mode.

According to the alternative exemplary embodiment, the standby movement signal is output in the output step 510, which is configured to cause the operating element to move under the cover element and/or the cover element to move over the operating element, in order to switch the operating device into the standby position.

The exemplary embodiments described herein and shown in the figures are selected merely by way of example. Different exemplary embodiments can be combined with one another, either entirely or with respect to individual features. An exemplary embodiment can also be supplemented by features of another exemplary embodiment. Furthermore, the method steps presented herein can be repeated or executed in a sequence other than that described herein.

### REFERENCE SYMBOLS

100 movement system
105 movement device
110 operating device
115 operating element
120 cover element
126 driving operating state signal
130 movement signal
135 operating position
140 control knob
300 standby position
500 method for moving a manually operable operating device for operating a function of a vehicle
505 input step
510 output step

1. A method for moving at least part of a manually operable operating device for operating a function of a vehicle,
wherein the operating device comprises an operating element and a cover element for at least partially covering the operating element, and
wherein the method comprises the following steps:
inputting a driving operating state signal that represents a selected operating state of the vehicle in a driving mode of the vehicle; and
outputting a movement signal that is configured to cause a movement of the operating element or the cover element depending on the input driving operating state signal.

2. The method according to claim 1, further comprising outputting an operating movement signal as the movement signal is output, wherein the operating movement signal is configured to cause a movement of the operating element or the cover element to an operating position of the operating element such that the operating element is accessible to a driver of the vehicle when the driving operating state signal is input in the input step and when the selected operating sate of the vehicle represents a manually controlled driving mode.

3. The method according to claim 2, wherein the operating movement signal is configured to cause the operating element to move out from under the cover element and/or the cover element to move away from the operating element.

4. The method according to claim 1, wherein a standby movement signal is output in the output step, wherein the standby movement signal is configured to cause the operating element or the cover element to move to a standby position of the operating device such that the operating element is inaccessible to a driver of the vehicle when the driving operating state signal is input in the input step and when the selected driving operating state of the vehicle represents a highly automated driving mode.

5. The method according to claim 4, wherein the standby movement signal is output in the output step to cause the operating element to move under the cover element and/or the cover element to move over the operating element in order to switch the operating device to move into the standby position.

6. A movement device that is configured to execute and/or actuate the steps of the method according to claim 1.

7. A movement system comprising a movement device according to claim 6 and the operating device for use in a vehicle.

8. The movement system according to claim 7, wherein the operating element includes a gear knob.

9. The movement system according to claim 7, wherein the cover element is formed as at least one of an armrest, an arm support, and a display.

10. (canceled)

11. (canceled)
